(19) United States
(12) Patent Application Publication
(10) Pub. No.: US 2026/0336155 A1
(43) Pub. Date: Oct. 29, 2026

(54) CUTTER HEAD SYSTEMS AND COMPONENTS THEREOF

(71) Applicant: Simonds International L.L.C., Woodland, WA (US)

(72) Inventors: Paul FOBY, Woodland, WA (US); John D. KLUGE, Springfield, OR (US); James WANKEL, Prince George (CA)

(21) Appl. No.: 19/662,609

(22) Filed: Apr. 29, 2026

Related U.S. Application Data
(60) Provisional application No. 63/796,943, filed on Apr. 29, 2025.

(51) Int. Cl. B27G 13/10; B23B 27/08; B23B 27/16

(52) U.S. Cl. CPC B27G 13/10; B23B 27/083; B23B 27/16

(57) ABSTRACT

Embodiments provide a cutter head body, a cutter head system, and corresponding gibs, gib assemblies, and knives. A groove in the periphery of the cutter head body has a front wall, a rear wall, an opening, and a bottom. The front wall is substantially planar and the rear wall defines a first locking feature. The front wall and the rear wall are inclined toward one another. The front and rear walls of the gib are inclined toward one another, and the gib is symmetrical about a longitudinal center plane. The front side of the knife is planar, and the back side has a second locking feature. Rotation of a fastener in a threaded through-hole of the gib urges the gib away from the bottom of the groove to clamp the knife between the gib and the rear wall of the groove with the locking features in engagement.

### CROSS-REFERENCE TO RELATED APPLICATIONS

The present application claims the benefit of U.S. Provisional Patent Application No. 63/796,943 filed Apr. 29, 2025 and titled “CUTTER HEAD SYSTEMS AND COMPONENTS THEREOF”, the entire disclosure of which is hereby incorporated by reference.

### TECHNICAL FIELD

The present disclosure relates to cutter head systems, components, and knives, all for use in wood cutting operations.

### BACKGROUND

The commercial production of finished lumber involves cutting/chipping logs into boards, drying the boards in a kiln, and planing the dried boards to a desired thickness. A typical industrial planer has cutter heads positioned above, below, and on both sides of a feed axis that extends through the planer. Successive boards are fed into the planer along the feed axis, and each of the cutter heads removes excess material from the corresponding face or side of the board. In addition to producing boards of relatively uniform thickness, planing also produces relatively smooth ‘finished’ surface along those along which the boards are fed into the planer.

Cutter heads, such as planer heads, are jointed to sharpen the knives as the cutting edges of the knives become dull. The jointing operation forms a “knife heel” along the knife. A cutter head can be jointed multiple times until the largest acceptable “knife heel” is reached. At that stage the knives must be changed. One type of cutter head, commonly known as an “In-Place” head, must have its knives changed while the cutter head remains in place on the planer machine. The other type of cutter head, commonly known as a “Removable” head, can be removed from the planer and replaced with another removable head with sharpened knives. This allows the operator to change the knives off-line with minimum downtime. Every 4-10 hours, the heavy knife heads must be removed, transported across the mill, and awkwardly placed into a grinder for resharpening. After sharpening, the knives are reinstalled at the start of the next shift, repeating the cycle. The process demands a high level of skill from the planer technician or mechanic, as the knives must be precisely set to avoid misalignments that could compromise lumber quality and result in defects. The process is inherently dangerous, involving heavy lifting and proximity to grinding machinery, which increases the risk of injury. The planer mill is not running during shift changes or while knives are being sharpened. The knives must be sharpened or replaced multiple times each day, leading to significant operational downtime that disrupts the mill's workflow and reduces overall productivity. The frequent interruptions cause inefficiencies and slow down the production process.

Existing systems in the market fail to address the full range of challenges, including the shortage of qualified labor, the risk of errors in knife alignment, and the inefficiencies of manual methods. As a result of the manual and outdated processes, sawmills continue to face operational inefficiencies that hinder both productivity and safety, while also increasing costs and the risk of quality defects.

### BRIEF DESCRIPTION OF THE DRAWINGS

Embodiments will be readily understood by the following detailed description in conjunction with the accompanying drawings. Embodiments are illustrated by way of example and not by way of limitation in the figures of the accompanying drawings.

FIG. 1A is an end view of a first cutter head body;

FIG. 1B is an enlarged view of a portion of FIG. 1A;

FIG. 1C is a side view of the cutter head body of FIG. 1A;

FIG. 2 is a perspective view of a first cutter head system;

FIG. 3 is an end view of the first cutter head system of FIG. 1;

FIG. 4 is a side view of the first cutter head system of FIGS. 1 and 2A;

FIGS. 5A-5B are perspective views of a first gib;

FIG. 5C illustrates a side view of a fastener of a first gib assembly;

FIGS. 5D and 5E illustrate a side view and plan view, respectively, of an alternative fastener of the second gib assembly;

FIGS. 6A-6C are plan, side, and end views, respectively, of the first gib of FIGS. 5A-5B;

FIGS. 7A-7E are views of a first knife for a cutter head;

FIGS. 8A-8D illustrate a method of installing the first knife in a groove of the first cutter head body;

FIG. 9A is an end view of a second cutter head body;

FIG. 9B is an enlarged view of a portion of FIG. 9A;

FIG. 9C is a side view of the cutter head body of FIG. 9A;

FIG. 10 is a perspective view of a second cutter head system;

FIG. 11 is an end view of the second cutter head system;

FIG. 12 is a side view of the second cutter head system;

FIGS. 13A-13B are perspective views of a second gib;

FIG. 13C illustrates a side view of a fastener of a second gib assembly;

FIGS. 13D and 13E illustrate a side view and plan view, respectively, of an alternative fastener of the second gib assembly;

FIGS. 14A-14C are plan, side elevational, and end views, respectively, of the second gib of FIGS. 13A-13B;

FIGS. 15A-15C are plan, end, and perspective views of a second knife;

FIGS. 15D-15F are end views of alternative second knife configurations; and

FIG. 16 illustrates a perspective, partially exploded view of the second cutter head system, all in accordance with embodiments of the present disclosure.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments except as follows. In the portions of the description that relate to knives and to the grooves of cutter head bodies, the terms “front” and “rear” and “back” are relative to the direction of rotation of the cutter head (or cutter head body). For example, a “front” wall or a “front” side is leading in, or positioned toward, the direction of rotation, while a “back” or “rear” wall or side is lagging in, or positioned away from, the direction of rotation.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous.

The present disclosure provides embodiments of cutter heads, cutter head bodies, cutter head systems, cutter head knives, gib assemblies, and related articles. In exemplary embodiments, a computing device may be endowed with one or more components of the disclosed apparatuses and/or systems and may be employed to perform one or more methods as disclosed herein.

In various embodiments, a cutter head includes a cutter head body with a first end, an opposite second end, a rotational axis that extends through the ends, an outer periphery, and a groove formed in the outer periphery between the ends. The groove has a front wall, a rear wall, an opening that extends from an upper edge of the front wall to an upper edge of the rear wall, and a bottom that extends from a lower edge of the front wall to a lower edge of the rear wall. The rear wall defines a locking feature (e.g., an elongated ridge or channel) that extends, parallel to the rotational axis, between the first end and the second end.

The front wall and the rear wall are inclined toward a groove center axis that extends through the opening and the bottom, such that the width of the opening (the distance from the upper edge of the front wall to the upper edge of the rear wall) is less than the width of the bottom (the distance from the lower edge of the front wall to the lower edge of the rear wall).

Optionally, the width of the bottom may be greater than the height of the front wall (the distance from the lower edge to the upper edge thereof), and/or the height of the rear wall may be greater than the width of the bottom. The locking feature may optionally be configured to engage a complementary feature on the back side of a knife.

In preferred embodiments, the front wall is substantially planar. A first portion of the rear wall that extends from the upper edge thereof to an upper edge of the locking feature is coplanar with a second portion of the rear wall that extends from a lower edge of the locking feature to the lower edge of the rear wall. The bottom has a substantially flat portion, a curved portion that extends from the lower edge of the front wall to the flat portion, and a recess that extends from the flat portion to the lower edge of the rear wall. The recess may be dimensioned to accommodate one end of a knife (e.g., one edge of a reversible knife) within the groove while an opposite edge of the knife is positioned for use. Optionally, the recess may have a center of curvature that is located within the recess. In other embodiments (e.g., head bodies designed for use with non-reversible knives), the recess may be shallower; alternatively the recess may be omitted, and the bottom may have a second curved portion that extends from the flat portion to the lower edge of the rear wall.

In some embodiments the front wall is optionally connected to the outer periphery of the cutter head body by a surface that is inclined away from the groove center axis. For example, the surface may be inclined away from the groove center axis at an angle of between 40° and 50°. However, this is not essential, and in other embodiments this surface may be inclined at a different angle or may be omitted.

Optionally, the head body may further include one or more additional grooves. Preferably, the grooves are spaced equally apart along the outer periphery of the head body. In preferred embodiments, the head body has an even number of grooves spaced equally apart along the outer periphery of the head body. As an example, the head body may have 2-48, or 8-42, or 12-38, or 16-34, or 20-30 grooves. In an illustrative embodiment, a head body for a planer side head has 24 grooves.

In some prior designs, holes were drilled or tapped into the head body to accommodate bolts that were required to secure knives or gibs in the knife pockets. As discussed further below, embodiments of head bodies describe herein do not require (and preferably lack) drilling or tapping holes in addition to the groove(s). Thus, the head bodies described herein may be made by cutting a groove into the outer periphery of a head body blank.

The diameter of the head body and the length of the head body (the distance from the first end to the second end) may vary based on factors such as the intended use of the cutter head. For example, a head body for a planer top head or a planer bottom head may be longer than a head body for a planer side head.

Therefore, in various embodiments, a method of forming a cutter head includes forming one or more grooves in the outer periphery of a head body blank. Optionally the method may further include forming the head body blank by machining a cylinder blank (e.g., a cylindrical steel bar) along an axial centerline thereof to form a first through-bore, and/or forming one or more fluid passages through the cylinder blank. In some embodiments the method may optionally further include installing a sleeve member within the first through-bore, wherein the sleeve member defines a second through-bore. In that case, the method may optionally further include machining the sleeve member within the second through-bore to thereby increase an actual diameter of the second through-bore to a desired diameter. Alternatively, the head body blank or component(s) thereof may be obtained (e.g., from a commercial supplier).

In various embodiments, the cutter head body is a component of a cutter head system (or cutter head assembly) that further includes a gib. The gib has a front side and a rear side that are inclined toward one another, a bottom side, a top side, and a through-hole that extends through the top side and the bottom side. At least a portion of the through-hole may have a threaded interior, such that the gib is configured to retain a fastener with a corresponding threaded exterior within the through-hole. For example, the fastener may be a set screw (also known as a ‘grub screw’), a headed screw, or other suitable type of fastener. In preferred embodiments the gib is symmetrical about a first center plane that extends through the top side, the bottom side, and the ends, and/or symmetrical about a second center plane that extends through the front, rear, top, and bottom sides. The top side of the gib may optionally have a recessed portion that is in axial alignment with the through-hole. In that case, the diameter of the recessed portion is typically greater diameter than the diameter of the through-hole. Optionally, if present, the recessed portion may facilitate the insertion and removal of the fastener and/or keep the fastener out of the path of chip flow.

Optionally, the cutter head system may further include the fastener. For example, in some embodiments the cutter head system includes the cutter head body and a gib assembly, and the gib assembly includes the gib and the fastener.

In some embodiments, the cutter head system may be a planer side head. In other embodiments, the cutter head system may be a planer top head or a planer bottom head. In various embodiments, a planer head system may include two planer side heads, a planer top head, and a planer bottom head.

The present disclosure also provides embodiments of a knife for a cutter head. In various embodiments, the knife has a front side, an opposite back side, first and second beveled faces that extend from the back side to respective first and second cutting edges along an outer periphery of the front side, and a locking feature that extends along a longitudinal centerline of the back side from a first end to an opposite second end of the knife. The knife is symmetrical about a first plane that extends through the front side and the back side, along the longitudinal centerline. The front side is flat and coplanar with the cutting edges. A first portion of the back side extends from the first beveled face to the locking feature and a second portion of the back side extends from the second beveled face to the locking feature, and the first and second portions of the back side are flat and coplanar.

The locking feature may be, for example, an elongated channel. The elongated channel may optionally be arcuate or semi-circular in profile. As an example, the elongated channel may be semi-circular in profile with a radius of between 0.115″ (2.921 mm) and 0.120″ (3.048 mm).

Preferably the knife has a first thickness along the first plane of between 0.115″ (2.921 mm) and 0.120″ (3.048 mm). The knife may also have a second thickness, between the locking feature and a respective one of the beveled faces, of between 0.110″ (2.794 mm) and 0.170″ (4.318 mm).

In some embodiments, the knife is configured for use with (or provided as a component of) a cutter head system such as a top planer head and/or a bottom planer head. In that case, the linear cutting edges typically extend from the first end to the second end. Each of the beveled faces may optionally form a substantially fixed angle relative to the front side.

In other embodiments, each of the cutting edges of the knife has a respective linear edge disposed between two concave arcuate edges, and the linear edges are parallel to the first plane. In that case, the knife may have a first attack relief angle along the linear edges and at least one second attack relief angle along the concave arcuate edges, and the second attack relief angle may be greater than the first attack relief angle. Optionally the concave arcuate edges are semi-circular and define a plurality of second attack relief angles that vary along at least a portion of each of the concave arcuate edges. A knife of this type may be configured for use in, and/or provided as a component of, a cutter head system such as a planer side head.

Optionally, the knife may optionally be symmetrical about a second plane that extends through the top side, the bottom sides, and the beveled faces, along a lateral centerline of the knife.

Embodiments of cutter head bodies, cutter head systems, gibs, gib assemblies, knives, and related assemblies/components are illustrated by way of example in the Figures.

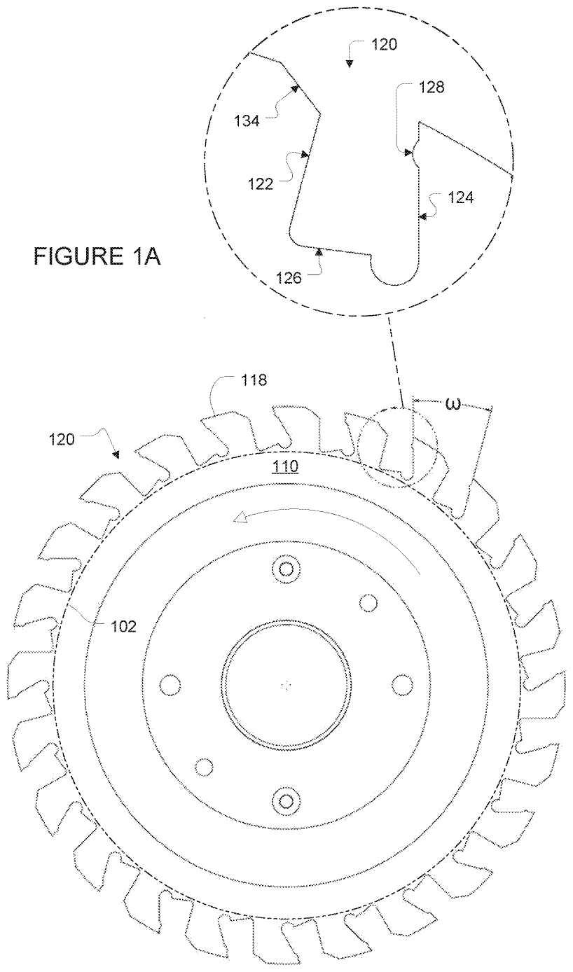

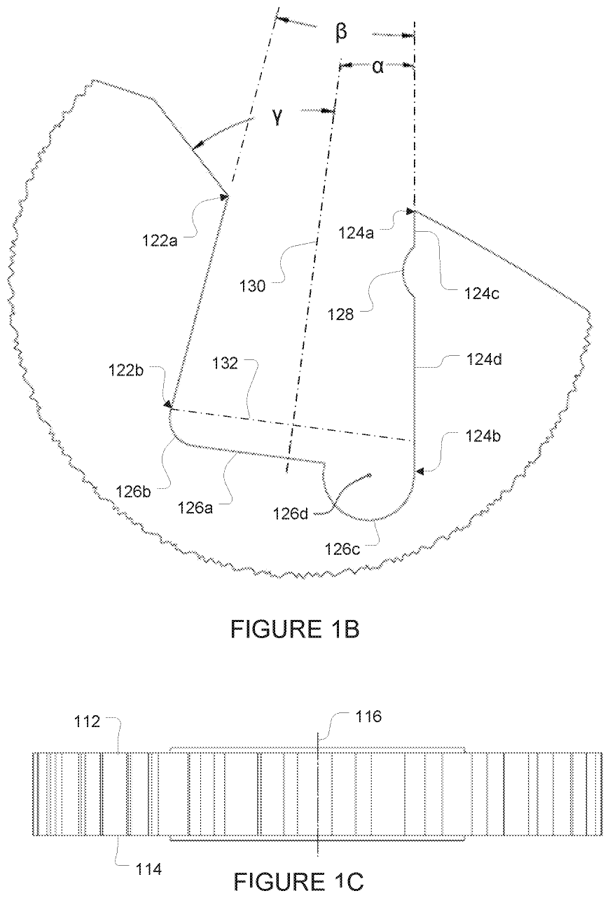

An embodiment of a first cutter head body is shown in FIGS. 1A-1C. In this example, cutter head body 110 is a cutter head body for a planer side head. While FIG. 1A is an end view of cutter head body 110, it may also be described as a plan view of the cutter head body 110 as it would be oriented in a planer machine.

Cutter head body 110 has a first end 112, an opposite second end 114, and a rotational axis 116 that extends through the ends 112 and 114, an outer periphery 118, and a groove 120 formed in the outer periphery between the ends. The groove 120 has a front wall 122, a rear wall 124, an opening that extends from an upper edge 122a of the front wall 122 to an upper edge 124a of the rear wall, and a bottom 126 that extends from a lower edge 122b of the front wall to a lower edge 124b of the rear wall. The rear wall 124 defines a locking feature 128 (e.g., an elongated ridge or channel) that extends, parallel to the rotational axis, between the first end 112 and the second end 114 of the cutter head body.

The front wall 122 and the rear wall 124 are inclined toward a groove center axis 130 that extends through the opening and the bottom, such that the width of the opening (the distance from the upper edge 122a of the front wall to the upper edge 124a of the rear wall) is less than the width of the bottom along a second axis 132 that extends, perpendicular to the groove center axis, from the lower edge 122b of the front wall to the rear wall. In some embodiments, the rear wall and the front wall form respective angles, relative to the groove center axis, that are of equal magnitude. In that case, the rear wall may extend at an angle α relative to the groove center axis 130, the front wall may extend an angle of equal magnitude relative to the groove center axis, such that an angle β of the front wall relative to the rear wall is twice the magnitude of angle α. For example, in the embodiment illustrated in FIG. 1B, angle α is 7.5 degrees and angle β is 15 degrees. In other embodiments, angle α may be an angle within a range of 3 degrees to 12 degrees, or 5 degrees to 10 degrees, and angle β may be an angle within the range of 6 degrees to 24 degrees, or 10 degrees to 20 degrees. In other embodiments the angle formed by the front wall relative to the groove center axis may be of greater or lesser magnitude than the angle formed by the rear wall relative to the groove center axis, and angle β may be more or less than twice the magnitude of angle α.

Optionally, the width of the bottom along the second axis 132 may be greater than the height of the front wall 122 (from the lower edge 122b to the upper edge 122a) and/or less than the height of the rear wall (from the lower edge 124b to the upper edge 124a).

In some embodiments, the front wall is substantially planar. A first portion 124c of the rear wall that extends from the upper edge 124a thereof to an upper edge of the locking feature is coplanar with a second portion 124d of the rear wall that extends from a lower edge of the locking feature to the lower edge 124b of the rear wall. The bottom has a substantially flat portion 126a, a curved portion 126b that extends from the lower edge of the front wall to the flat portion, and a recess 126c that extends from the flat portion to the lower edge of the rear wall. The recess 126c may be dimensioned to accommodate one end of a knife (e.g., a reversible knife) within the groove while an opposite end of the knife is positioned for use.

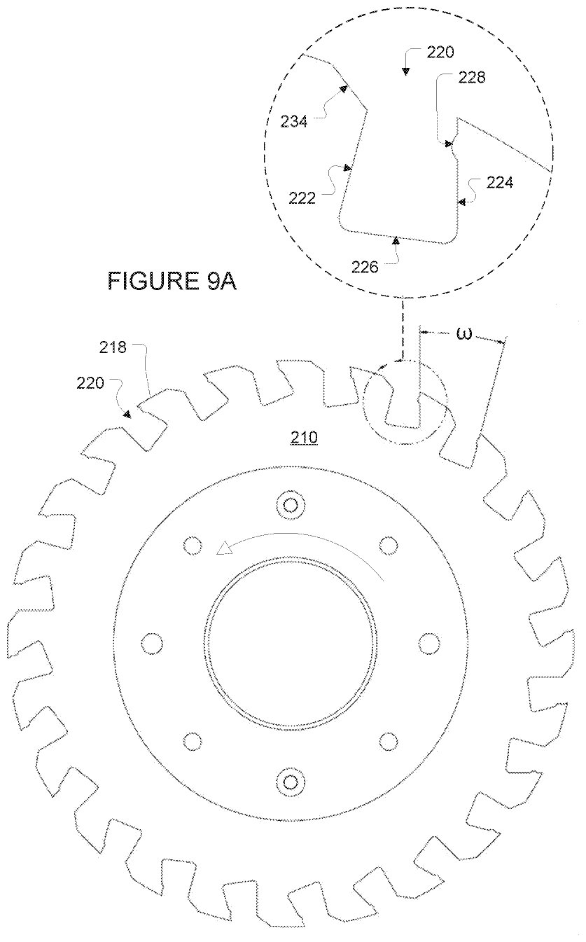

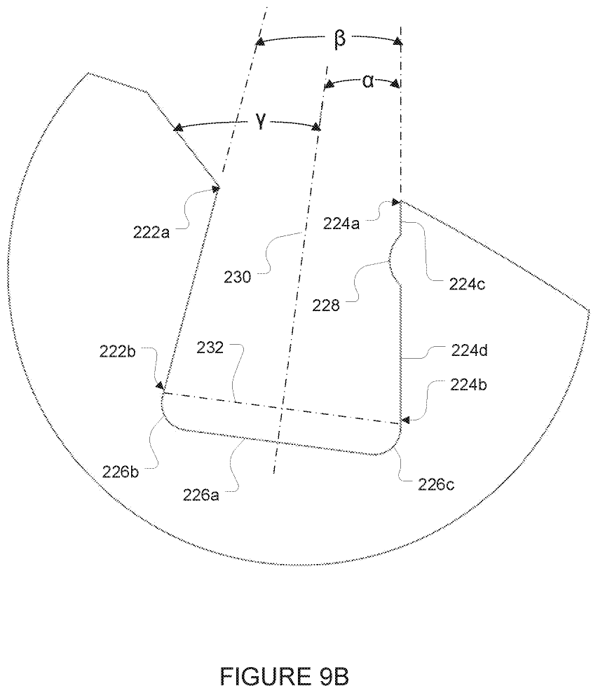

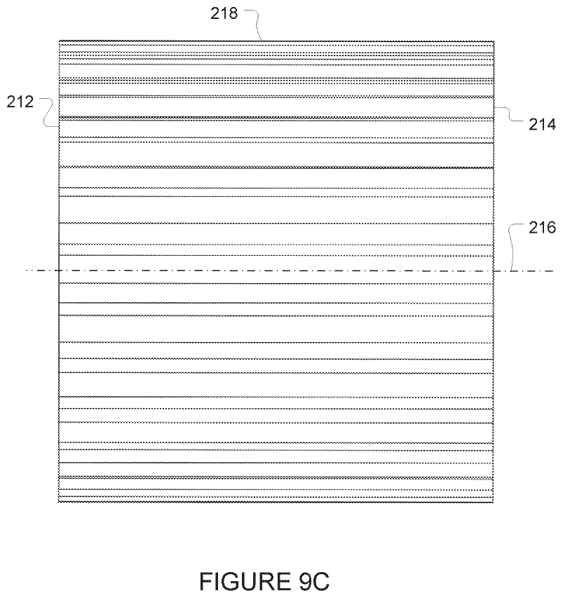

In some embodiments, the recess 126c has a center of curvature 126d that is located within the recess, as shown for example in FIG. 1B. In that case, a linear distance from the rotational axis to the recess may optionally be equal to, or greater than, a linear distance from the rotational axis to the curved portion 126b. (See e.g. FIG. 1A, in which broken line 102 indicates an imaginary circle representing a fixed linear distance from the rotational axis.) Alternatively, the center of curvature may be located outside of the recess (e.g., within the groove but above the flat portion). For example, in some cutter head bodies that are intended for use with knives that are non-reversible and/or dimensioned to be accommodated by a shallower recess, the center of curvature of the recess may be located within the groove, above the flat portion of the bottom. In still other embodiments, such as the embodiment illustrated in FIGS. 9A-9C, the recess may be omitted and the bottom may instead have a second curved portion that extends from the flat portion to the lower edge of the rear wall.

The locking feature 128 extends, parallel to the rotational axis 116, between the first end 112 and the second end 114. Preferably the locking feature extends continuously from first end 112 to second end 114, but this is not essential. For example, the locking feature may instead be discontinuous and/or extend less than the full length of the groove 120. The locking feature is preferably an elongated ridge or channel that is arcuate or semi-circular in cross-section. In some embodiments, locking feature 128 is an elongated ridge that is semi-circular in cross-section and protrudes, relative to the first and second portions 124a and 124b of the rear wall, into groove 120. However, in other embodiments the locking feature may be a channel. Likewise, the locking feature need not be arcuate or semi-circular in cross-section. An arcuate or semi-circular profile may facilitate the insertion and removal of a knife with a complementary locking feature on the back side of the knife (as discussed further below). However, in other embodiments the locking feature 128 may have an angular, curvilinear, or other cross-sectional shape suitable to engage a complementary locking feature on the back side of a knife.

In some embodiments the front wall 122 is be connected to the outer periphery 118 of the cutter head body by a surface 134 that is inclined away from the groove center axis 130. In that case, the surface 134 may extend at an angle γ relative to the groove center axis. For example, in the illustrated embodiment the angle γ is 45 degrees. In other embodiments angle γ may be an angle within a range of 30 degrees to 60 degrees, or 40 degrees to 50 degrees, or 43 degrees to 47 degrees. In other embodiments the surface 134 may be inclined at a different angle, or surface 134 may be omitted (e.g., with front wall 122 extending to outer periphery 118).

The diameter of the cutter head body and the length of the cutter head body (the distance from the first end to the second end) may vary based on factors such as the intended use of the cutter head. For example, a cutter head body for a planer top head or a planer bottom head may be longer and/or of greater diameter than a cutter head body for a planer side head.

Optionally, the cutter head body 110 may further include one or more additional grooves 120. In that case the grooves are preferably spaced equally apart along the outer periphery of the cutter head body. In preferred embodiments the cutter head body has an even number of grooves spaced equally apart along the outer periphery of the cutter head body. The cutter head body 110 shown in FIGS. 1A-1C has 24 grooves. However, in other embodiments the cutter head body may have 2-48, or 8-42, or 12-38, or 16-34, or 20-30, or more than 48, grooves.

In some embodiments, the first portion 124c of the rear wall of one groove extends at an angle ω relative to the first portion 124c of the rear wall of the next groove. As an example, in the embodiment illustrated in FIG. 1A, angle ω is 15 degrees. In other embodiments angle ω may be an angle of 5 to 45 degrees, or 10 to 25 degrees, or any other suitable angle.

Embodiments of cutter head systems described herein include a cutter head body and a gib.

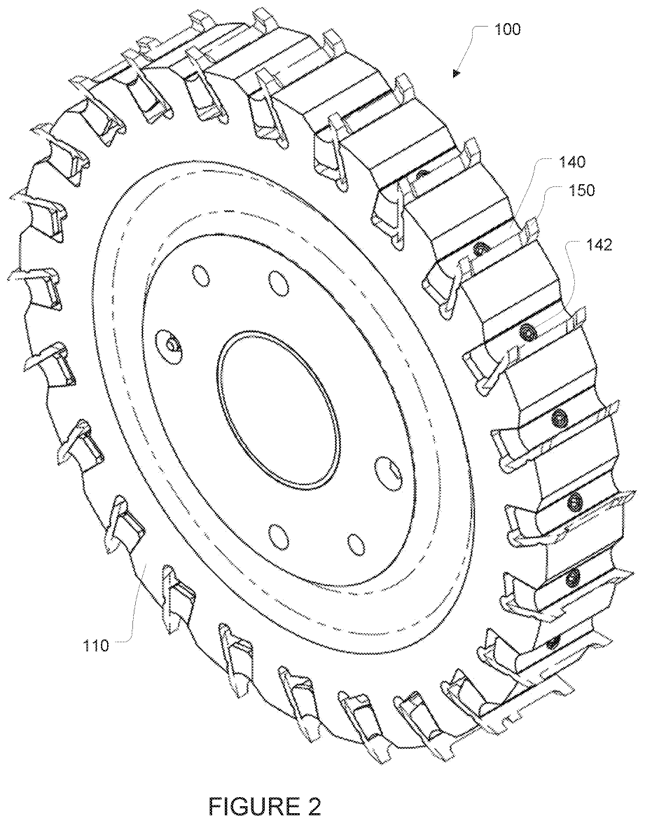

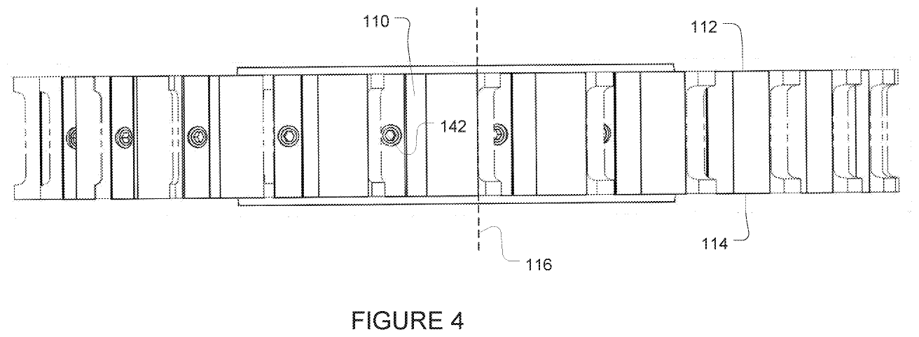

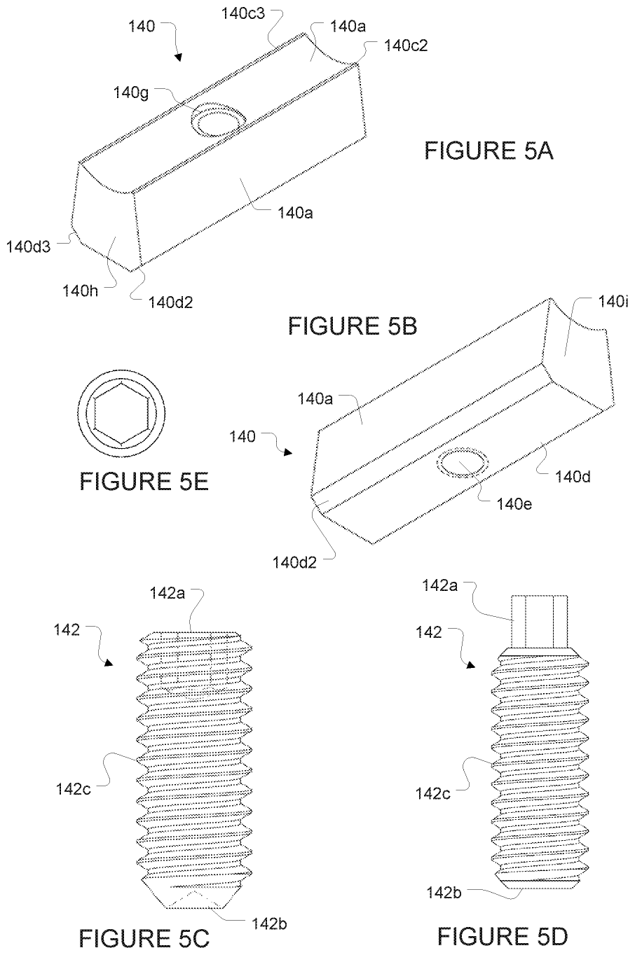

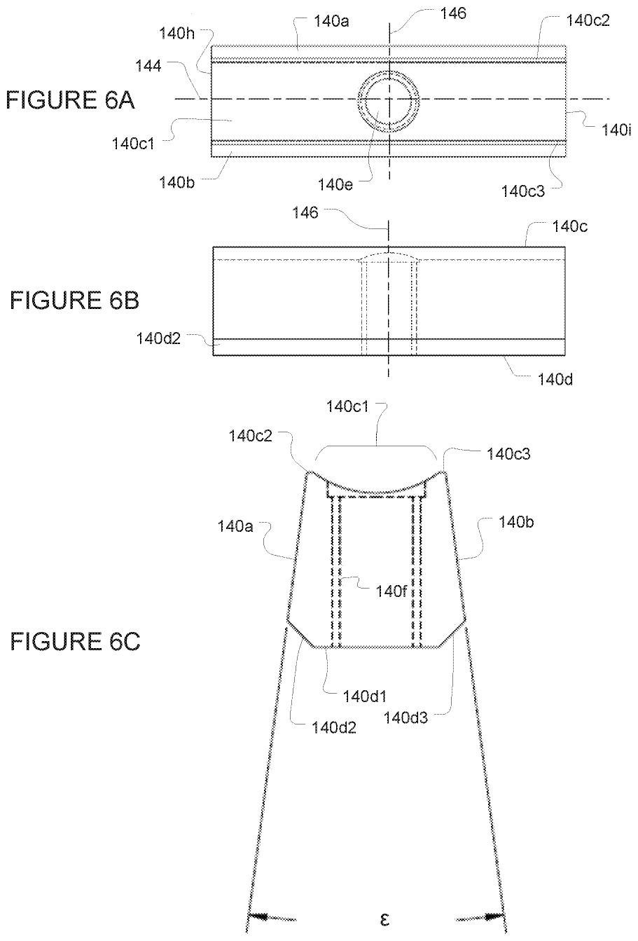

A first cutter head system 100 is illustrated in FIGS. 2-4, and an example of a gib and corresponding fastener (collectively a ‘gib assembly’) is shown in FIGS. 5A-6C. For clarity and ease of explanation, cutter head system 100 is shown with cutter head body 110 as illustrated in FIGS. 1A-1C. However, this is not intended to be limiting. In other embodiments of cutter head systems/assemblies, the cutter head body may have any of the configurations/features described herein.

Referring now to FIGS. 2-6C, gib 140 has a front side 140a and a rear side 140b that are inclined toward one another, a bottom side 140d, a top side 140c, first and second ends 140h and 140i, and a through-hole 140e that extends through the top side 140c and the bottom side 140d. Gib 140 is symmetrical about a first center plane 144 that extends through the top side, the bottom side, the through-hole, and the ends.

At least a portion of the through-hole 140e has a threaded interior 140f that is configured to engage a threaded exterior 142c of a corresponding fastener 142, such that rotation of the fastener 142 in a first rotary direction within the through-hole 140e is operable to bring a bottom end 142b of the fastener into contact with the bottom 126 of the groove to thereby urge the gib 140 from a first position, in which the bottom side 140d of the gib is in contact with the bottom 126 of the groove, to a second position in which the top side 140c of the gib is proximal to the opening of the groove and the front side 140a of the gib is in abutment with the front wall 122 of the groove, to clamp a knife between the rear side 140b of the gib and the rear wall 124 of the groove. In some embodiments the fastener may be a set screw or other headless screw (see e.g., FIG. 5C). In other embodiments the fastener may be a headed screw (see e.g., FIGS. 5D and 5E). In still other embodiments another type of fastener may be used.

The top side of the gib may optionally have a recessed portion 140g that is in axial alignment with the through-hole 140e. In that case, the diameter of the recessed portion 140g may be greater than the diameter of the threaded interior 140f of the through-hole 140e. If present, the recessed portion 140g may optionally facilitate the insertion and removal of the fastener. Optionally the top end 142a of the fastener 142 is flush with, or recessed relative to, the top of the gib when the gib is in the second position.

Optionally, gib 140 may also be symmetrical about a second center plane 146 that extends through the front side, the rear side, and the through-hole.

In some embodiments, the front side 140a and the rear side 140b may form an angle ε. For example, in the illustrated embodiment, angle ε is an angle of 15 degrees (FIG. 6C). However, in other embodiments, angle ε may be any suitable angle and is typically within the range of 5 to 25 degrees.

In some embodiments the fastener 142 is a headless screw (e.g., a set screw) with a top end 142a and an opposite bottom end 142b. In such embodiments, top 142a has an interior void that is shaped to receive a tool, optionally a hexagonal bit or wrench, that can be used to turn fastener 142 about an axis of rotation that passes through the longitudinal center of the fastener. In other embodiments the fastener 142 is a headed screw, and the top end 142a is shaped to engage a tool, optionally a hexagonal socket wrench/tool, that can be used to turn fastener 142 about an axis of rotation that passes through the longitudinal center of the fastener. In still other embodiments the fastener may be another type of screw, a bolt, or any other suitable type of fastener. The bottom end of the fastener is typically flat or cupped (i.e., having a concave indentation terminating in a ring-shaped edge), but other shapes (e.g., rounded and convex) are also possible.

Optionally, the top side 140c of the gib may have a first portion 140c1 that is curved in cross-section, a second portion 140c2 that joins the first portion 140c1 to the front side 140a of the gib, and a third portion 140c3 that joins the first portion 140c1 to the rear side 140b of the gib. The curvature of the top side may help to guide a flow of chips as they are removed from the lumber. Second portion 140c2 and third portion 140c3 may be flat and coplanar. Alternatively, one or both of the first and second portions 140c2 and 140c3 may be flat and inclined toward one another (not coplanar), curved, or omitted.

Optionally the bottom side of the gib has a first portion 140d1 that is flat in cross-section, a second portion 140d2 that joins the first portion 140d1 of the bottom side to the front side 140a of the gib, a third portion 140d3 that joins the first portion 140d1 of the bottom side to the rear side 140b of the gib, and the second and third portions 140d2 and 140d3 are inclined away from one another in cross-section.

In some embodiments, the gib and the fastener may be provided as a gib assembly. Similarly, in some embodiments a cutter head system includes the cutter head body and a gib assembly, and the gib assembly includes the gib and the fastener. Alternatively, a cutter head system may omit the fastener. For example, if the through-hole of the gib is configured to receive a fastener (e.g., a set screw or a headed screw) of a standard size that is readily available from multiple suppliers, the fastener may be omitted. In some embodiments the cutter head system may further include a knife.

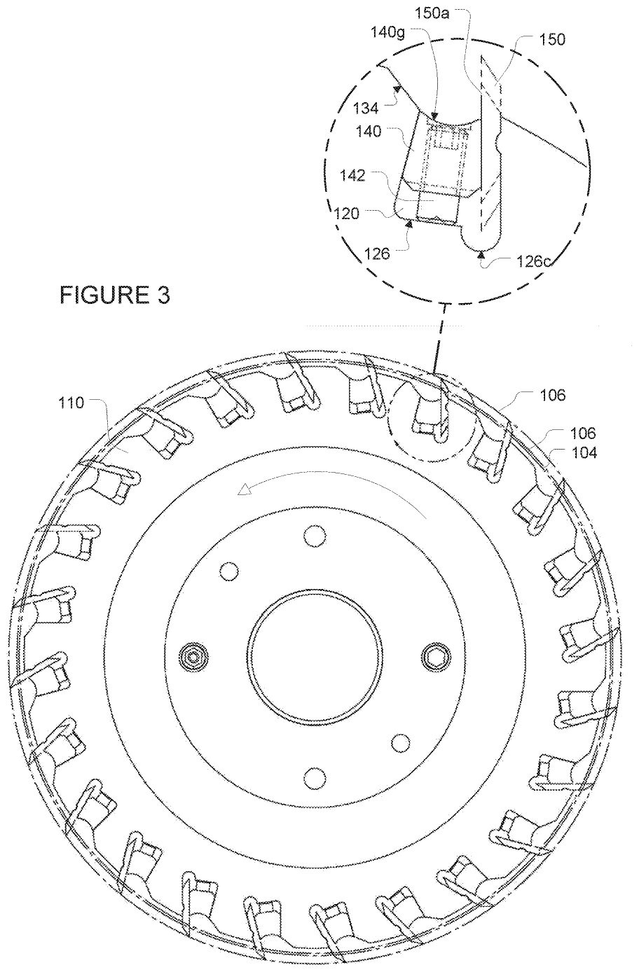

In this example, the cutter head system 100 is a planer side head. A minimum cutting circle 104, a typical cutting circle 106, and a third circle 108 that represents the path of the distal knife tip are shown in broken lines by way of example in FIG. 3.

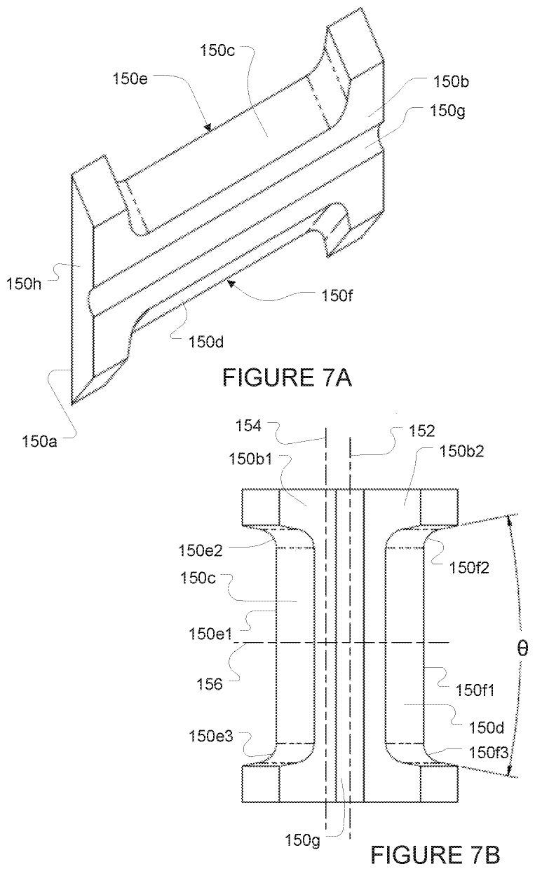

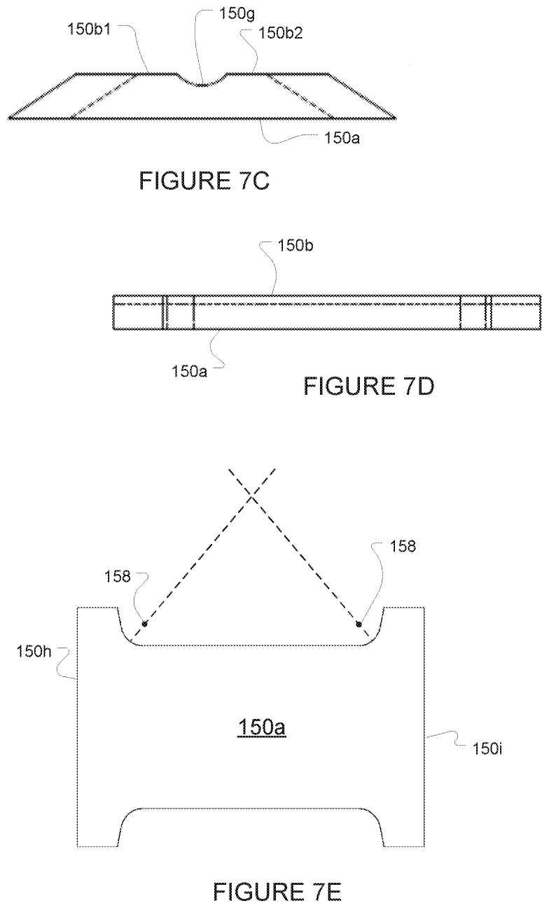

A corresponding knife is shown by way of example in FIGS. 7A-7E. In this embodiment, the knife is a reversible knife.

Knife 150 has a front side 150a, an opposite back side 150b, first and second beveled faces 150c and 150d that extend from the back side to respective first and second cutting edges 150e and 150f along an outer periphery of the front side, and a locking feature 150g that extends along a longitudinal centerline of the back side from a first end 150h to an opposite second end of the knife 150i. The knife is symmetrical about a first plane 152 that extends through the front side and the back side, along the longitudinal centerline. The front side 150a is flat. Optionally, front side 150a may be coplanar with the cutting edges 150e and 150f. The back side 150b has a first portion 150b1 that extends from the first beveled face 150c to the locking feature 150g and a second portion 150b2 that extends from the second beveled face 150d to the locking feature 150g. The first and second portions 150b1 and 150b2 of the back side are flat and coplanar.

In some embodiments, the locking feature is an elongated ridge or channel. Preferably the locking feature is arcuate or semi-circular in cross-section. For example, if the locking feature on the back wall of the groove of the cutter head body (e.g., locking feature 128) is an elongated ridge that is arcuate or semi-circular in profile, the locking feature along the back side of the knife (e.g., locking feature 150g) may be an elongated channel that is arcuate or semi-circular in profile. If the locking feature on the back wall of the groove of the cutter head body is an elongated channel, the locking feature on the back side of the knife may be an elongated ridge. In the illustrated embodiment, the locking feature 150g is an elongated channel that is semi-circular in cross-section and has a depth, relative to the first and second portions of the back side of the knife, of about 0.039″ (about 1 mm). However, the elongated channel may have any suitable depth, typically between 0.030″ (0.762 mm) and 0.05″ (1.270 mm).

The locking feature 150g extends between the first end 150h and the second end 150i. Preferably the locking feature extends continuously from first end 150h to second end 150i, but this is not essential. For example, the locking feature may instead be discontinuous and/or extend less than the full length of the back side 150b of the knife. Likewise, the locking feature need not be arcuate or semi-circular in cross-section. An arcuate or semi-circular profile may facilitate the insertion and removal of the knife with a complementary locking feature on the rear wall of the groove of the cutter head body (as discussed further below). However, in other embodiments the locking feature of the knife may have an angular, curvilinear, or other cross-sectional shape suitable to engage a complementary locking feature on the rear wall of the groove of the cutter head body.

Preferably the knife 150 has a first thickness, along the first plane 152, of between 0.115″ (2.921 mm) and 0.120″ (3.048 mm). The knife may optionally have a second thickness, along a second plane 154 that extends through the first portion 150b1 of the back side, parallel to the first plane 152, of between 0.110″ (2.794 mm) and 0.170″ (4.318 mm).

Each of the cutting edges 150e and 150f has a respective linear edge (150e1, 150f1) disposed between two concave arcuate edges (150e2 and 150e3, 150f2 and 150f3), and the linear edges are parallel to the first plane 152. Relative to the front side of the knife, the beveled faces form a first relief angle along the linear edges and a second relief angle along the concave arcuate edges.

For example, in the illustrated embodiment, the first angle is about 33 degrees. In other embodiments, the first angle may be in the range of 30-36 degrees, or any other suitable angle. Optionally the second angle may be greater than the first angle. Similarly, the concave arcuate edges may optionally be semi-circular, and/or the second relief angle may optionally be a plurality of second relief angles that vary along at least a portion of each of the concave arcuate edges.

In some embodiments, the concave arcuate edges are semi-circular, each having a respective center of curvature (or radius of curvature) 158. In that case, vectors extending from the centers of the two concave arcuate edges of a given cutting edge through their respective centers of curvature 158 converge, or cross one another, at some distance from the cutting edge (see e.g., FIG. 7E).

In some embodiments, the terminal ends of each cutting edge may extend outwardly to form an angle θ. In the illustrated embodiment, angle θ is 22 degrees. However, this angle varies among embodiments, and is typically in the range of 15-30 degrees or 20-24 degrees. Again, this is optional, and in other embodiments the terminal ends of a cutting edge may extend outwardly along parallel axes.

Optionally, the knife may be symmetrical about a third plane 156 that extends through the top side, the bottom sides, and the beveled faces, perpendicular to the first plane 152.

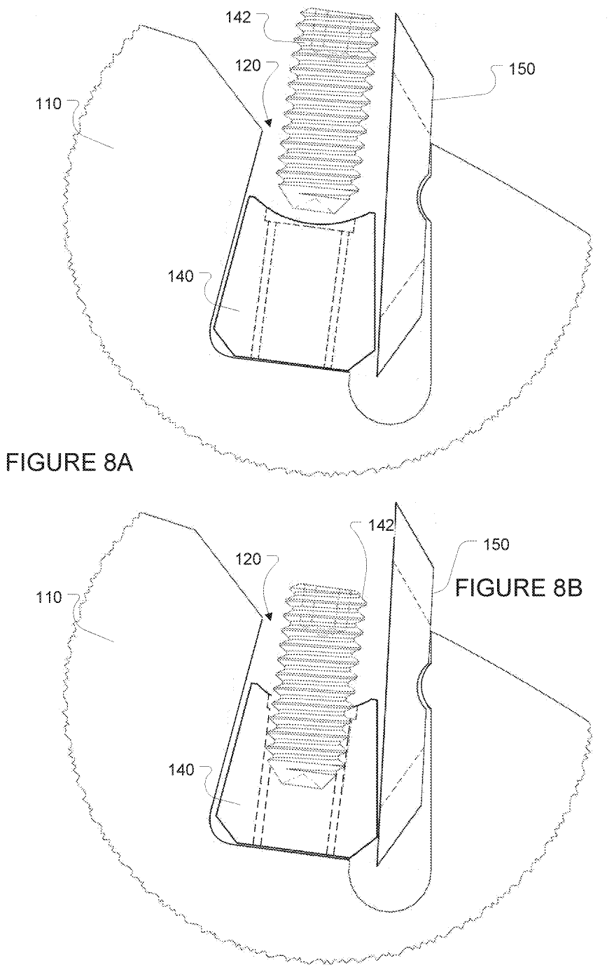

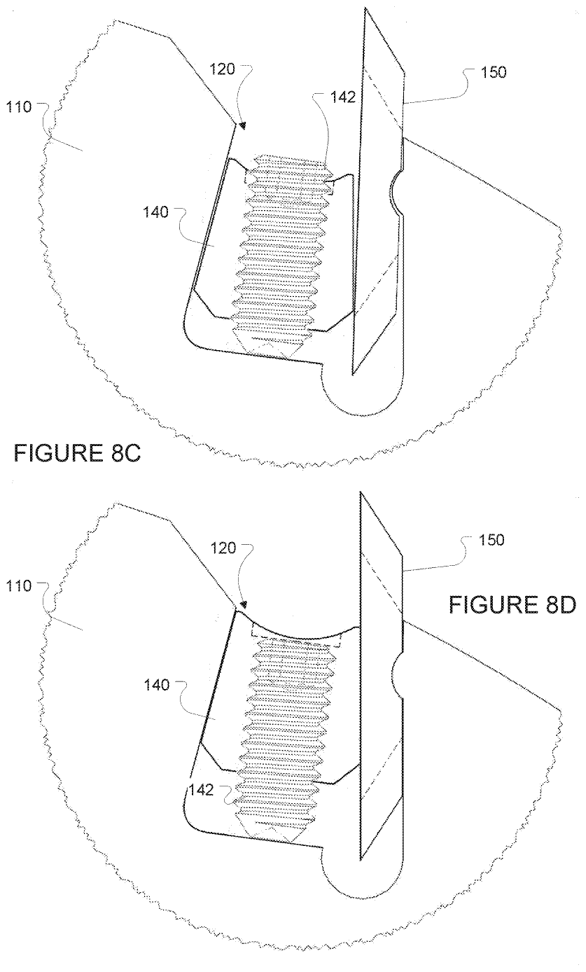

Referring now to FIGS. 8A-8D, knife 150 may be installed in the groove 120 of cutter head body 110 as follows. The gib 140 may be placed into the groove 120 (e.g., by inserting the gib axially into the groove through an end of the cutter head body, or by inserting the gib through the opening of the groove) with the bottom side of the gib in contact with, or resting on, the bottom 126 of the groove (the first position-see e.g., FIGS. 8A and 8B). Before inserting the gib into the groove, or while the gib is in the first position, fastener 142 may be inserted into the through-hole of the gib and rotated in a first rotary direction to drive the fastener toward the bottom side of the gib. Knife 150 may be inserted into the gap between the rear side of the gib and the rear wall of the groove, such that the locking feature along the back side of the knife is generally aligned with the locking feature along the rear wall of the groove. Once fastener 142 is in contact with the bottom side of the groove, further rotation of the fastener in the first rotary direction forces the gib toward the opening of the groove until the gib reaches the second position, in which the front wall of the gib abuts the front wall of the groove, the rear wall of the gib abuts the front side of the knife, and the back side of the knife abuts the rear wall of the groove, with the locking feature along the back side of the knife engaged by the locking feature along the back wall of the groove.

To release or remove the knife or the gib, the fastener may be rotated in a second rotary direction, opposite to the first rotary direction, to drive the fastener upwardly through the gib until the bottom of the fastener is near or within the through-hole. The gib may then be pressed or tapped downwardly to release the knife and/or to return the gib to the first position. With the gib at or near the first position, the knife and/or the gib may be moved axially out of the groove through an end of the cutter head body, or removed through the opening of the groove.

A second cutter head body is shown in FIGS. 9A-9C, in accordance with embodiments of the present disclosure. While the first cutter head body 110 shown in FIGS. 1A-1C is an example of a cutter head body for a planer side head, the cutter head body 210 of FIGS. 9A-9C is an example of a cutter head body for a planer top or bottom head. While FIG. 9C is a side view of cutter head body 210, it may also be described as a plan view of the cutter head body 210 as it would be oriented after installation in a planer machine.

Cutter head body 210 has a first end 212, an opposite second end 214, and a rotational axis 216 that extends through the ends 212 and 214, an outer periphery 218, and a groove 220 formed in the outer periphery between the ends. The groove 220 has a front wall 222, a rear wall 224, an opening that extends from an upper edge 222a of the front wall to an upper edge 224a of the rear wall, and a bottom 226 that extends from a lower edge 222b of the front wall to a lower edge 224b of the rear wall. The rear wall 224 defines a locking feature 228 (e.g., an elongated ridge or channel) that extends, parallel to the rotational axis, between the first end 212 and the second end 214 of the cutter head body.

The front wall 222 and the rear wall 224 are inclined toward a groove center axis 230 that extends through the opening and the bottom 226, such that the width of the opening (the distance from the upper edge 222a of the front wall to the upper edge 224a of the rear wall) is less than the width of the bottom along a second axis 232 that extends, perpendicular to the groove center axis, from the lower edge 222b of the front wall to the rear wall. In some embodiments, the rear wall and the front wall form respective angles, relative to the groove center axis, that are of equal magnitude. In that case, the rear wall may extend at an angle α relative to the groove center axis 230, the front wall may extend an angle of equal magnitude relative to the groove center axis, such that an angle β of the front wall relative to the rear wall is twice the magnitude of angle α. For example, in the embodiment illustrated in FIGS. 9A-9C, angle α is 7.5 degrees and angle β is 15 degrees. In other embodiments, angle α may be an angle within a range of 3 degrees to 12 degrees, or 5 degrees to 10 degrees, and angle β may be an angle within the range of 6 degrees to 24 degrees, or 10 degrees to 20 degrees. In other embodiments the angle formed by the front wall relative to the groove center axis may be of greater or lesser magnitude than the angle formed by the rear wall relative to the groove center axis, and angle β may be more or less than twice the magnitude of angle α.

Optionally, the width of the bottom along the second axis 232 may be greater than the height of the front wall 222 (from the lower edge 222b to the upper edge 222a) and/or less than the height of the rear wall (from the lower edge 224b to the upper edge 224a).

In preferred embodiments, the front wall is substantially planar. A first portion 224c of the rear wall that extends from the upper edge 224a thereof to an upper edge of the locking feature is coplanar with a second portion 224d of the rear wall that extends from a lower edge of the locking feature to the lower edge 224b of the rear wall. The bottom has a substantially flat portion 226a, a curved portion 226b that extends from the lower edge of the front wall to the flat portion, and a second curved portion 226c that extends from the flat portion to the lower edge of the rear wall.

In other embodiments, the bottom may have a recess that extends from the flat portion to the lower edge of the rear wall, such as the recess described above in reference to the first cutter head body 110 (see e.g., FIG. 1B, recess 126c). Such a recess may be provided, for example, in embodiments of cutter head bodies that are intended for use with knives that are wider than the height of the back wall.

The locking feature 228 extends, parallel to the rotational axis 216, between the first end 212 and the second end 214. Preferably the locking feature extends continuously from first end 212 to second end 214, but this is not essential. For example, the locking feature may instead be discontinuous and/or extend less than the full length of the groove 220. The locking feature is preferably an elongated ridge or channel that is arcuate or semi-circular in cross-section. In some embodiments, locking feature 228 is an elongated ridge that is semi-circular in cross-section and protrudes, relative to the first and second portions 224a and 224b of the rear wall, into groove 220. However, in other embodiments the locking feature may be a channel. Likewise, the locking feature need not be arcuate or semi-circular in cross-section. An arcuate or semi-circular profile may facilitate the insertion and removal of a knife with a complementary locking feature on the back side of the knife (as discussed further below). However, in other embodiments the locking feature 228 may have an angular, curvilinear, or other cross-sectional shape suitable to engage a complementary locking feature on the back side of a knife.

In some embodiments the front wall 222 is connected to the outer periphery 218 of the cutter head body by a surface 234 that is inclined away from the groove center axis 230. In that case, the surface 234 may extend at an angle γ relative to the groove center axis. For example, in the illustrated embodiment the angle γ is 45 degrees. In other embodiments angle γ may be an angle within a range of 30 degrees to 60 degrees, or 40 degrees to 50 degrees, or 43 degrees to 47 degrees. In other embodiments the surface 234 may be inclined at a different angle, or surface 234 may be omitted (e.g., with front wall 222 extending to outer periphery 218).

The diameter of the cutter head body and the length of the cutter head body (the distance from the first end to the second end) vary among embodiments, and are selected based on factors such as the intended use of the cutter head. For example, a cutter head body intended for use in a particular machine will have a length and diameter that the machine is configured to accommodate. A cutter head body for a planer top head or a planer bottom head may be longer than a cutter head body for a planer side head, and it may have the same diameter or a different diameter. As a specific example, for a particular planer system, the cutter head bodies for the planer top head and bottom head (e.g., cutter head bodies 210) and the cutter head bodies for the planer side heads (e.g., cutter head bodies 110) each have a diameter of 13″ to 14″ (330.2 mm to 355.6 mm), the cutter head bodies for the planer side heads have a length of 2″ to 3″ (50.8 mm to 76.2 mm), and the cutter head bodies for the planer top and bottom heads have a length of 13″ (330.2 mm). This example is not intended to be limiting, as cutter head bodies in accordance with the present disclosure may be of any length and diameter suitable for use in other planer systems and other types of milling machines.

Optionally, the cutter head body 210 may further include one or more additional grooves 220. In that case the grooves are preferably spaced equally apart along the outer periphery of the cutter head body. In preferred embodiments the cutter head body has an even number of grooves spaced equally apart along the outer periphery of the cutter head body. The cutter head body 210 shown in FIGS. 9A-9C has 24 grooves. However, in other embodiments the cutter head body may have 2-48, or 8-42, or 12-38, or 16-34, or 20-30 grooves.

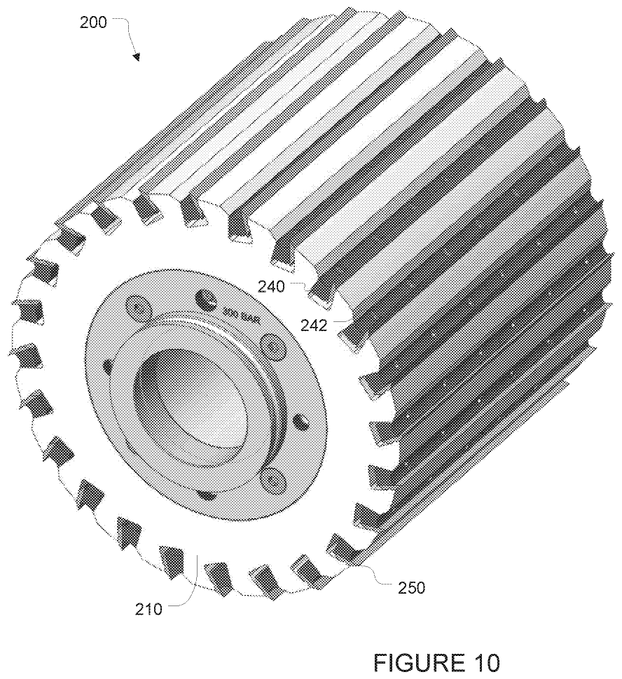

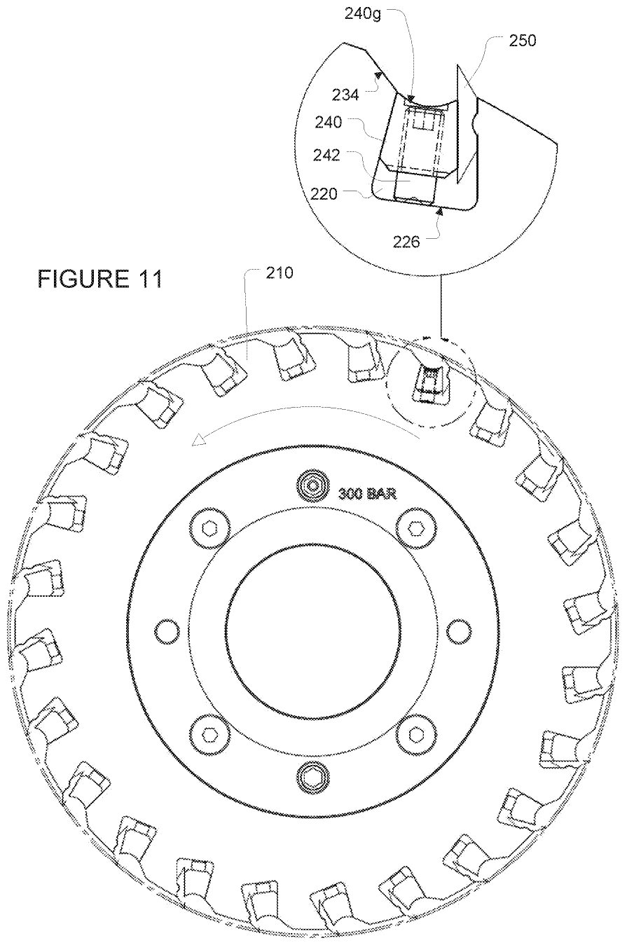

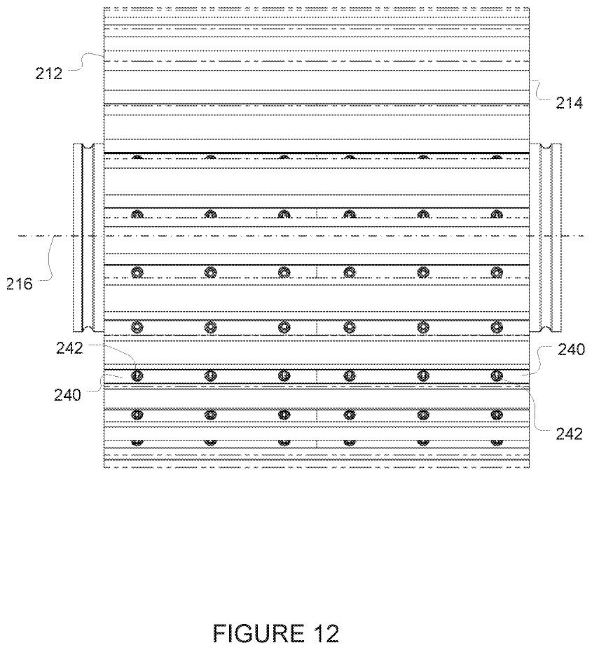

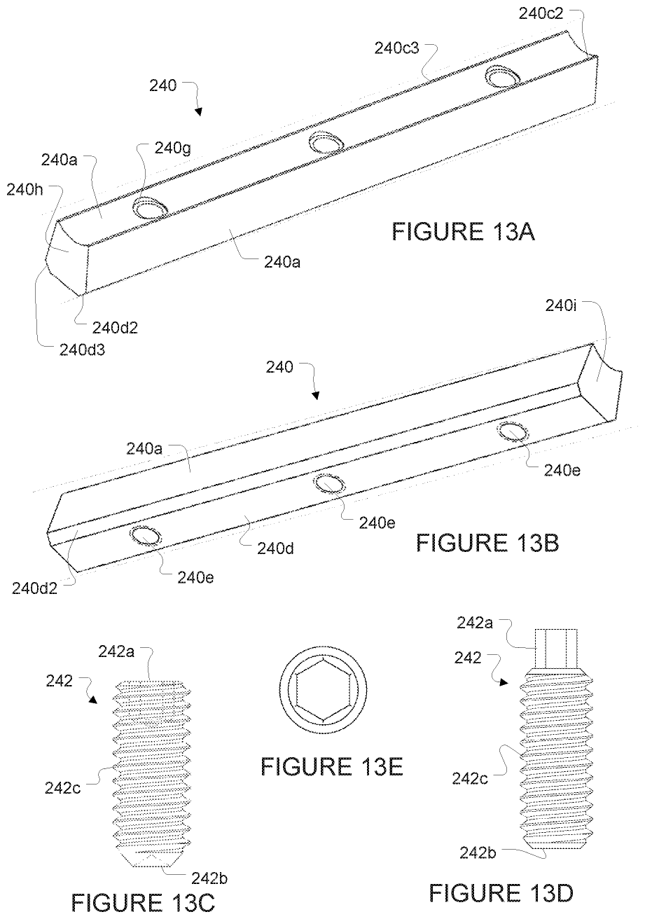

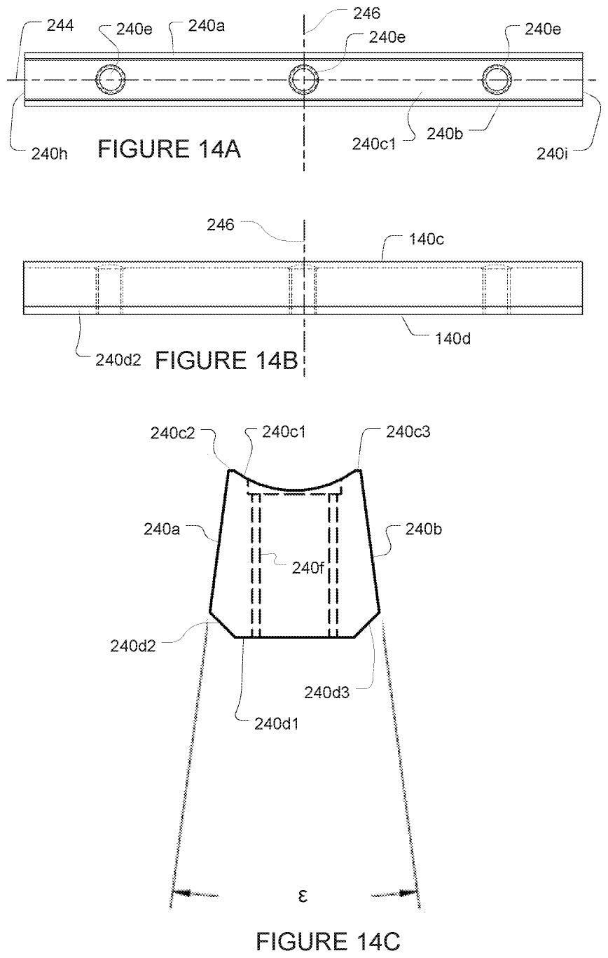

A second cutter head system is illustrated in FIGS. 10-12. In this example, the second cutter head system 200 (e.g., a planer top head or a planer bottom head) includes cutter head body 210 and a gib. A corresponding gib 240 and a fastener are shown in FIGS. 13A-14C. In combination, the gib(s) and the fastener(s) may be collectively referred to as a ‘gib assembly.’ Again, cutter head system 200 is shown with a cutter head body 210 as illustrated in FIGS. 1A-1C by way of example, and in other embodiments the cutter head body may have any of the configurations/features described herein.

Referring now to those Figures, gib 240 has a front side 240a and a rear side 240b that are inclined toward one another, a bottom side 240d, a top side 240c, first and second ends 240h and 240i, and a through-hole 240e that extends through the top side 240c and the bottom side 240d. Gib 240 is symmetrical about a first center plane 244 that extends through the top side, the bottom side, the through-hole, and the ends.

At least a portion of the through-hole 240e has a threaded interior 240f that is configured to engage a threaded exterior 242c of a corresponding fastener 242, such that rotation of the fastener 242 in a first rotary direction within the through-hole 3 is operable to bring a bottom end 242b of the fastener into contact with the bottom 226 of the groove to thereby urge the gib 240 from a first position, in which the bottom side 240d of the gib is in contact with the bottom 226 of the groove, to a second position in which the top side 240c of the gib is proximal to the opening of the groove and the front side 240a of the gib is in abutment with the front wall 222 of the groove, to clamp a knife between the rear side 240b of the gib and the rear wall 224 of the groove. In some embodiments the fastener may be a set screw or other headless screw (see e.g., FIG. 13C). In other embodiments the fastener may be a headed screw (see e., g., FIGS. 13D and 13E). In still other embodiments another type of fastener may be used.

The top side of the gib may optionally have a recessed portion 240g that is in axial alignment with the through-hole 240e. In that case, the diameter of the recessed portion 240g may be greater than the diameter of the threaded interior 240f of the through-hole 240e. If present, the recessed portion 240g may facilitate the insertion and removal of the fastener. Preferably the top end 242a of the fastener 242 is flush with, or recessed relative to, the top of the gib when the gib is in the second position.

In some embodiments the gib may have multiple through-holes. Gib 240 is shown with three through-holes 240e arranged at intervals along the length of the gib, each in axial alignment with a corresponding recessed portion 240g. In other embodiments, the gib may have more or fewer than three through-holes. Optionally, the number of through-holes may correspond to the length of the gib, with longer gibs having a larger number of through-holes.

Optionally, gib 240 may also be symmetrical about a second center plane 246 that extends through the front side and the rear side, perpendicular to the first center plane 244.

In some embodiments, the front side 240a and the rear side 240b may form an angle ε. In the illustrated embodiment, angle ε is an angle of 15 degrees (FIG. 14C). However, in other embodiments, angle ε may be any suitable angle and is typically within the range of 5 to 25 degrees.

Fastener 242 may be a headless screw (e.g., a set screw), a headed screw, or any other suitable screw, bolt, or threaded fastener, as described herein with reference to fastener 142.

Optionally, the top side 240c of the gib may have a first portion 240c1 that is curved in cross-section, a second portion 240c2 that joins the first portion 240c1 to the front side 240a of the gib, and a third portion 240c3 that joins the first portion 240c1 to the rear side 240b of the gib. Second portion 240c2 and third portion 240c3 may be flat and coplanar. Alternatively, one or both of the first and second portions 240c2 and 240c3 may be flat and inclined toward one another (not coplanar), curved, or omitted.

Optionally the bottom side of the gib has a first portion 240d1 that is flat in cross-section, a second portion 240d2 that joins the first portion 240d1 of the bottom side to the front side 240a of the gib, a third portion 240d3 that joins the first portion 240d1 of the bottom side to the rear side 240b of the gib, and the second and third portions 240d2 and 240d3 are inclined away from one another in cross-section.

The length of the gib may correspond to the length of a knife, or the length of a cutter head body (from the first end to the second end) or groove thereof, with which the gib is intended for use. For example, in embodiments that use only one gib to hold the knife in the groove, the length of the gib may be equal to the length of the cutter head body and/or the knife. Alternatively, in embodiments that use multiple gibs to hold the knife in the groove, each of the gibs may be a fraction of the length of the cutter head body, and the collective length of the gibs may be equal to the length of the cutter head body and/or the knife. For example, in the embodiment of the cutter head system 200 shown in FIGS. 10-12, the groove 220 accommodates two gibs, each having a length that is half the length of the cutter head body 210, and one knife that is equal in length to the length of the cutter head body 210. Instead of two gibs, the cutter head system could instead use a single gib of equal length to the cutter head body. However, in relatively long cutter head bodies, using multiple gibs to secure one knife in the groove may facilitate adjustment or replacement of the knife/gib(s). As another alternative, the cutter head system could instead use three gibs that are each one-third the length of the cutter head body, or two gibs that are each one-quarter of the length of the cutter head body and a third gib that is one-half the length of the cutter head body, etc.

Again, the gib(s) and the fastener(s) may be provided as a gib assembly. Likewise, some cutter head systems may include the cutter head body and a gib assembly (which includes the gib and the fastener(s)). Alternatively, a cutter head system may omit the fastener(s). For example, if the fasteners are standard fasteners that are commercially available, the fasteners may be omitted.

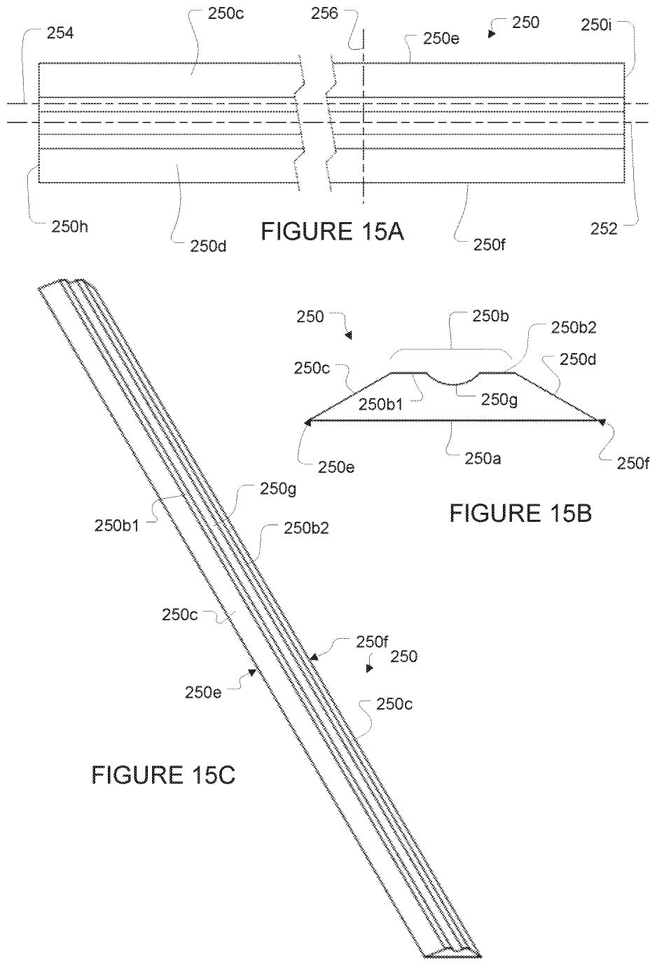

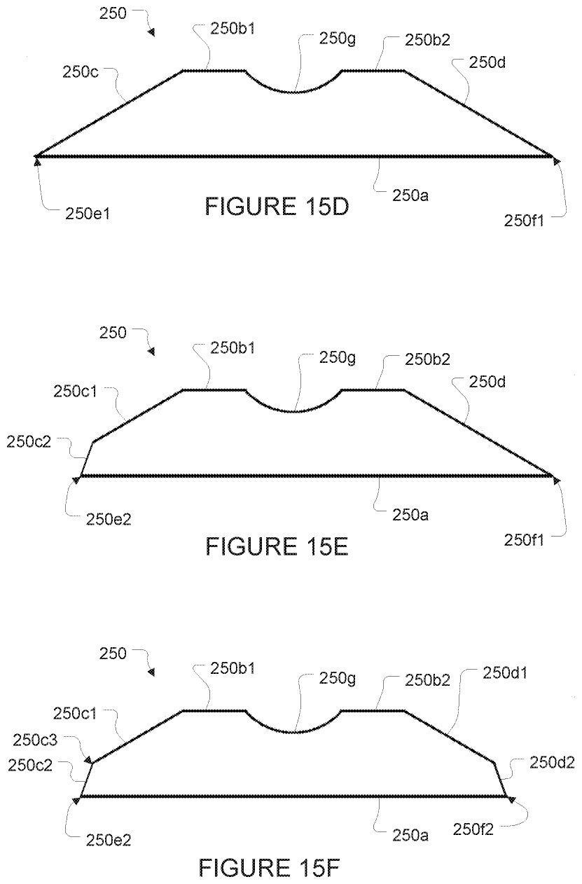

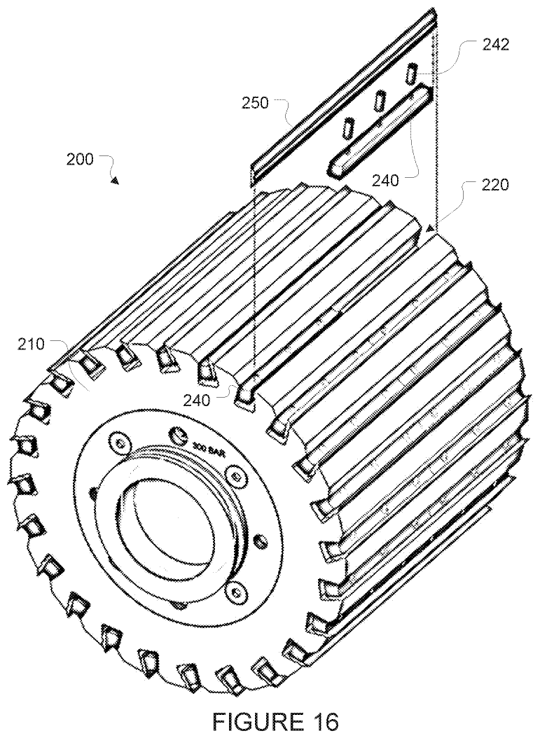

FIGS. 15A-15E illustrate a second embodiment of a knife 250. Again, in this embodiment the knife is reversible. Knife 250 has a front side 250a, an opposite back side 250b, first and second beveled faces 250c and 250d that extend from the back side to respective first and second cutting edges 250e and 250f along an outer periphery of the front side, and a locking feature 250g that extends along a longitudinal centerline of the back side from a first end 250h to an opposite second end 250i of the knife. The knife 250 is symmetrical about a first plane 252 that extends through the front side and the back side, along the longitudinal centerline. The front side 250a is flat. Optionally, front side 250a may be coplanar with the cutting edges 250e and 250f. The back side 250b has a first portion 250b1 that extends from the first beveled face 250c to the locking feature 250g and a second portion 250b2 that extends from the second beveled face 250d to the locking feature 250g. The first and second portions 250b1 and 250b2 of the back side are flat and coplanar.

In some embodiments, the beveled faces are flat. In other embodiments, at least one of the beveled faces has two or more sections that are not coplanar. For example, knife 250 may be produced with flat beveled faces 250c and 250d that extend to cutting edges 250e and 250f, respectively (see e.g., FIGS. 15A-15C). When one of the original cutting edges (shown in FIG. 15D as cutting edges 250e1 and 250f1) becomes dull or worn, a jointing/sharpening operation may be performed. In this operation, the knife is ground or machined to remove material along the original cutting edge to form a new surface, or “heel”, that extends from a remaining portion of the respective beveled face (the “first section” of the beveled face) to a new cutting edge. In FIG. 15E, knife 250 has been jointed/sharpened to form a new cutting edge 250e2; the respective beveled face has a first section 250c1 and a second section 250c2 that extends from the cutting edge 250e2 to first section 250c1 at an angle thereto. In FIG. 15F, knife 250 has been jointed/sharpened to form a second new cutting edge 250f2, with the respective beveled face having a first section 250d1 and a second section 250d2 that extends at an angle to first section 250c1.

In some embodiments, the locking feature is an elongated ridge or channel. Preferably the locking feature is arcuate or semi-circular in cross-section. For example, if the locking feature on the back wall of the groove of the cutter head body (e.g., locking feature 228) is an elongated ridge that is arcuate or semi-circular in profile, the locking feature along the back side of the knife (e.g., locking feature 250g) may be an elongated channel that is arcuate or semi-circular in profile. If the locking feature on the back wall of the groove of the cutter head body is an elongated channel, the locking feature on the back side of the knife may be an elongated ridge. In the illustrated embodiment, the locking feature 250g is an elongated channel that is semi-circular in cross-section and has a depth, relative to the first and second portions of the back side of the knife, of about 0.039″ (about 1 mm). However, the elongated channel may have any suitable depth, typically between 0.030″ (0.762 mm) and 0.05″ (1.270 mm).

The locking feature 250g extends between the first end 250h and the second end 250i. Preferably the locking feature extends continuously from first end 250h to second end 250i, but this is not essential. For example, the locking feature may instead be discontinuous and/or extend less than the full length of the back side 250b of the knife. Likewise, the locking feature need not be arcuate or semi-circular in cross-section, but may instead have an angular, curvilinear, or other cross-sectional shape suitable to engage a complementary locking feature on the rear wall of the groove of the cutter head body.

Preferably the knife 250 has a first thickness, along the first plane 252, of between 0.115″ (2.921 mm) and 0.120″ (3.048 mm). The knife may optionally have a second thickness, along a second plane 254 that extends through the first portion 250b1 of the back side, parallel to the first plane 252, of between 0.110″ (2.794 mm) and 0.170″ (4.318 mm).

In contrast to knife 150, the cutting edges of knife 250 (cutting edges 250e and 250f) are linear from the first end 250h to the opposite second end 250i of the knife. Each of the beveled faces 250c and 250d forms a first relief angle relative to the front side of the knife. In the illustrated example, the first relief angle is about 30 degrees. In other embodiments, the first relief angle may be in the range of 25-35 degrees, or any other suitable angle.

Optionally, the knife may be symmetrical about a third plane 256 that extends through the top side, the bottom sides, and the beveled faces, perpendicular to the first plane 252.

The knife 250 may be installed in the groove 220 of cutter head body 210 in the same or similar manner described above with reference to knife 150 and cutter head body 110, except that in cutter head system 200, two gibs 240 and multiple fasteners 242 are used to secure a knife in the groove. Referring now to FIG. 16, gibs 240 may be placed into the groove 220 (e.g., by inserting each gib axially into the groove through an end of the cutter head body or through the opening of the groove) with the bottom sides of the gibs in contact with, or resting on, the bottom 226 of the groove. Fasteners 242 may be inserted into the through-holes of the gibs and rotated in a first rotary direction to drive the fasteners toward the bottom sides of the gibs. Knife 250 may be inserted into the gap between the rear sides of the gibs and the rear wall of the groove, such that the locking feature along the back side of the knife is generally aligned with the locking feature along the rear wall of the groove. Once fasteners 242 are in contact with the bottom side of the groove, further rotation of the fasteners in the first rotary direction forces the gibs toward the opening of the groove until the gibs reach the second position, in which the front walls of the gibs abut the front wall of the groove, the rear walls of the gibs abut the front side of the knife, and the back side of the knife abuts the rear wall of the groove, with the locking feature along the back side of the knife engaged by the locking feature along the back wall of the groove.

To release or remove the knife or the gibs, the fasteners may be rotated in a second rotary direction, opposite to the first rotary direction, to drive the fasteners upwardly through the gibs until the bottoms of the fasteners are near or within the through-hole and/or the gibs have returned to the first position. The knife/gibs may then be moved axially out of the groove through one or both ends of the cutter head body or removed through the opening of the groove.

Many prior cutter heads use bolts to secure the knives and gibs in the knife pockets, which required bolt holes to be drilled or tapped into the cutter head body. In contrast, embodiments of cutter head bodies described herein lack bolt holes, and can be produced by cutting the groove(s) into the outer periphery of a cutter head body or cutter head body blank.

Therefore, in various embodiments, a method of forming a cutter head (or cutter head body) includes forming at least one groove in the outer periphery of a cutter head body blank. The cutter head body blank further includes a first end, an opposite second end, and a rotational axis that extends through the ends. The outer periphery extends between the ends and around the rotational axis. The groove has a front wall, a rear wall, an opening that extends from an upper edge of the front wall to an upper edge of the rear wall, and a bottom that extends from a lower edge of the front wall to a lower edge of the rear wall. The front wall is substantially planar, and the rear wall defines a first locking feature that extends, parallel to the rotational axis, between the first end and the second end. The front wall and the rear wall are inclined toward a groove center axis that extends through the opening and the bottom, such that a width of the opening from the upper edge of the front wall to the upper edge of the rear wall is less than a width of the bottom from the lower edge of the front wall to the lower edge of the rear wall.

In some embodiments, the width of the bottom is greater than a height of the front wall from the lower edge to the upper edge thereof. The height of the rear wall from the lower edge to the upper edge thereof may be greater than the width of the bottom. The rear wall may have a first portion that extends from the upper edge thereof to an upper edge of the first locking feature, and a second portion that extends from a lower edge of the first locking feature to the lower edge of the rear wall, and the first portion of the rear wall may be coplanar with the second portion of the rear wall.

In some embodiments, the first locking feature may be an elongated ridge or channel. The ridge or channel may be arcuate or semi-circular in cross-section. For example, the first locking feature may be an elongated ridge that is semi-circular in cross-section.

In some embodiments, the bottom may have a substantially flat portion, a first curved portion that extends from the lower edge of the front wall to the flat portion, and a second curved portion that extends from the flat portion to the lower edge of the rear wall.

In other embodiments the bottom may have a substantially flat portion, a curved portion that extends from the lower edge of the front wall to the flat portion, and a recess that extends from the flat portion to the lower edge of the rear wall, to thereby accommodate a first end of a knife within the groove while an opposite second end of the knife is positioned for use.

Optionally the front wall may be connected to the outer periphery by a surface that is inclined away from the groove center axis.

The cutter head bodies, cutter head systems/assemblies, gibs, and other components disclosed herein may provide one or more advantages over prior systems.

First, many prior cutter head systems use bolts to secure the knife or gib within a knife pocket. Thus, in addition to the machining required to form the knife pockets, the bolt holes must also be drilled or tapped into the cutter head body. This can be costly and time-consuming. Removing material from the cutter head body to form the bolt holes-particularly when the bolt holes extend through the bottoms of the knife pockets-may weaken the cutter head body, increasing the risk of flexing or cracking. Moreover, the bolts are typically oriented to force to the gibs inwardly (e.g., toward the axis of rotation). As such, the bolts apply force in a direction that is opposite or transverse to the centrifugal force created by high-speed rotation of the cutter head. The bolt holes also tend to wear due to the induction of grit and pressure during tightening and loosening of the bolts.

In contrast, embodiments of cutter head bodies disclosed herein can be produced by machining the groove(s) in a cutter head body blank, without drilling or tapping bolt holes into the body. In the cutter head systems described herein, the groove and the gib assembly are configured to apply force against the gib in an outward direction. As a result, centrifugal force induced by high-speed rotation of the cutter head body enhances the locking force applied against the knife, helping to secure the knife in the desired position during cutting operations. The complementary locking features on the back side of the knife and the rear wall of the groove of the cutter head body may facilitate the positioning of the knife during insertion and enhance the stability of the knife while the knife is in use.

Further, cutter head systems in accordance with embodiments of the present disclosure may allow a user to insert and remove the knife and the gib(s) in two ways—by inserting them axially through the end(s) of the cutter head body or by inserting them through the opening of the groove. The gib(s) can be moved from the first position to the second position to insert and remove the knife without removing the gib(s). The cutter head bodies experience relatively little wear due to the insertion and removal of the gibs and the knives, which are replaceable wear items.

Some prior cutter heads rely on a hydraulic locking system to lock the knives into place. The hydraulic locking system is relatively complex, and if hydraulic force is lost, the knives may fall out. Corrugated knives are often used in those systems to provide extra mechanical support. In comparison, the cutter head bodies disclosed herein may be simpler and more economical to manufacture, and they enable the use of non-corrugated knives of full standard thicknesses, which enhances the stability of the cutting edges.

The present designs also provide a wider engagement between the cutter body head and the gib(s) than prior designs, which may provide improved heat dissipation. Further, in conventional cutter heads with tapped bolt holes in the head body, only one side of the gib is well-supported. In comparison, the present designs provide solid contact on both sides (front and rear) of the gib and on both sides (front and rear) of the knife.

Embodiments of knives described herein may be made in a conventional process, heat-treated, and ground. Alternatively, they may be made in an extrusion process. In comparison to knifes with corrugations or locking features on the front side of the knife, the knives described herein may be easier and/or more economical to manufacture, grind, and/or sharpen.

In some embodiments, a planer head system may include a top planer head, a bottom planer head, and two side planer heads, with cutter head bodies and gibs/gib assemblies (and optionally, knives) as described herein.

### EXAMPLES

In some embodiments, a cutter head comprises a cutter head body having a first end, an opposite second end, a rotational axis that extends through the ends, an outer periphery, and a groove formed in the outer periphery between the ends, wherein the groove has a front wall, a rear wall, an opening that extends from an upper edge of the front wall to an upper edge of the rear wall, and a bottom that extends from a lower edge of the front wall to a lower edge of the rear wall. The front wall is substantially planar and the rear wall defines a first locking feature that extends, parallel to the rotational axis, between the first end and the second end. The front wall and the rear wall are inclined toward a groove center axis that extends through the opening and the bottom, such that a width of the opening from the upper edge of the front wall to the upper edge of the rear wall is less than a width of the bottom from the lower edge of the front wall to the lower edge of the rear wall. Optionally, the width of the bottom is greater than a height of the front wall from the lower edge to the upper edge thereof.

Optionally, in any of the foregoing embodiments of a cutter head, a height of the rear wall from the lower edge to the upper edge thereof is greater than the width of the bottom.

Optionally, in any of the foregoing embodiments of a cutter head, the rear wall has a first portion that extends from the upper edge thereof to an upper edge of the first locking feature, and a second portion that extends from a lower edge of the first locking feature to the lower edge of the rear wall, and the first portion of the rear wall is coplanar with the second portion of the rear wall.

Optionally, in any of the foregoing embodiments of a cutter head, the first locking feature is an elongated ridge or channel. In some such embodiments, the ridge or channel is arcuate or semi-circular in cross-section. For example, optionally the first locking feature is an elongated ridge that is semi-circular in cross-section.

Optionally, in some of the foregoing embodiments of a cutter head, the bottom has a substantially flat portion, a first curved portion that extends from the lower edge of the front wall to the flat portion, and a second curved portion that extends from the flat portion to the lower edge of the rear wall. Alternatively, in others of the foregoing embodiments of a cutter head, the bottom has a substantially flat portion, a curved portion that extends from the lower edge of the front wall to the flat portion, and a recess that extends from the flat portion to the lower edge of the rear wall, to thereby accommodate a first end of a knife within the groove while an opposite second end of the knife is positioned for use.

Optionally, in any of the foregoing embodiments of a cutter head, the front wall is connected to the outer periphery by a surface that is inclined away from the groove center axis.

In some embodiments, a cutter head system comprises a cutter head (e.g., a cutter head as described herein or recited in any of the claims) and a gib. The gib has a front side and a rear side that are inclined toward one another, a bottom side, a top side, a first end and an opposite second end, and a through-hole that extends through the top side and the bottom side. The gib is symmetrical about a first center plane that extends through the top side, the bottom side, the ends, and the through-hole. At least a portion of the through-hole has a threaded interior configured to engage a threaded exterior of a corresponding fastener, such that rotation of the fastener in a first rotary direction within the through-hole is operable to bring a bottom end of the fastener into contact with the bottom of the groove to thereby urge the gib from a first position, in which the bottom side of the gib is in contact with the bottom of the groove, to a second position in which the top side of the gib is proximal to the opening and the front side of the gib is in abutment with the front wall of the groove to thereby clamp a knife between the rear side of the gib and the rear wall of the groove.

Optionally, the cutter head system may include the fastener, wherein the fastener is a screw.

Optionally, in any of the foregoing embodiments of a cutter head system, the top side of the gib has a recessed portion in axial alignment with the through-hole, and a diameter of the recessed portion is greater than a diameter of the through-hole.

Optionally, in any of the foregoing embodiments of a cutter head system, a top end of the fastener is recessed within the recessed portion of the gib or within the through-hole while the gib is in the second position.

Optionally, in any of the foregoing embodiments of a cutter head system, the gib is symmetrical about a second center plane that extends through the front side, the rear side, and the through-hole, perpendicular to the first center plane.

Optionally, in any of the foregoing embodiments of a cutter head system, the top side of the gib has a first portion that is curved in cross-section, a second portion that joins the first portion to the front side of the gib, and a third portion that joins the first portion to the rear side of the gib. In some such embodiments, the second and third portions are flat and coplanar.

Optionally, in any of the foregoing embodiments of a cutter head system, the bottom side of the gib has a first portion that is flat in cross-section, a second portion that joins the first portion of the bottom side to the front side of the gib, a third portion that joins the first portion of the bottom side to the rear side of the gib, and the second and third portions are inclined away from one another in cross-section.

Optionally, in any of the foregoing embodiments of a cutter head system, the cutter head system further includes a knife, wherein the knife has a front side, an opposite back side, first and second beveled faces that extend from the back side to respective first and second cutting edges along an outer periphery of the front side, and said second locking feature extending along a longitudinal centerline of the back side from a first end to an opposite second end of the knife. The knife is symmetrical about a first plane that extends through the front side and the back side along said longitudinal centerline. The front side is flat and coplanar with the cutting edges. The back side of the knife has a first portion that extends from the first beveled face to the second locking feature and a second portion that extends from the second beveled face to the second locking feature, and said first and second portions of the back side of the knife are flat and coplanar. Optionally, in some such embodiments, the cutting edges are linear from a first end of the knife to an opposite second end of the knife. Optionally each of the cutting edges has a respective linear edge disposed between two concave arcuate edges, and the linear edges are parallel to the longitudinal centerline of the back side of the knife.

In some embodiments, a knife for a cutter head adapted to rotate the knife about an axis of revolution has a front side, an opposite back side, first and second beveled faces that extend from the back side to respective first and second cutting edges located along an outer periphery of the front side, and a locking feature that extends along a longitudinal centerline of the back side from a first end to an opposite second end of the knife. The knife is symmetrical about a first plane that extends through the front side and the back side, along said longitudinal centerline. The front side is flat. The back side has a first portion that extends from the first beveled face to the locking feature and a second portion that extends from the second beveled face to the locking feature, and said first and second portions of the back side are flat and coplanar.

Optionally, the locking feature is an elongated ridge or channel that is arcuate or semi-circular in cross-section.

Optionally, in any of the foregoing embodiments of a knife, the knife has a first thickness, along the first plane, of between 0.115″ (2.921 mm) and 0.120″ (3.048 mm). In some such embodiments, the knife has a second thickness along a second plane that extends through the first portion of the back side, parallel to the first plane, of between 0.110″ (2.794 mm) and 0.170″ (4.318 mm).

Optionally, in any of the foregoing embodiments of a knife, the locking feature is an elongated channel that is semi-circular in cross-section. In some such embodiments, the elongated channel is semi-circular in cross-section and has a depth, relative to the first and second portions of the back side of the knife, of between 0.030″ (0.762 mm) and 0.05″ (1.270 mm).

Optionally, in any of the foregoing embodiments of a knife, the cutting edges are linear from the first end to the second end of the knife.

Optionally, in any of the foregoing embodiments of a knife, each of the cutting edges has a respective linear edge disposed between two concave arcuate edges, the linear edges are parallel to the first plane, and the knife has a first relief angle along the linear edges and a second relief angle along the concave arcuate edges, and the second relief angle is greater than the first relief angle. In some such embodiments, the concave arcuate edges are semi-circular and the second relief angle is a plurality of second relief angles, and the second relief angles vary along at least a portion of each of the concave arcuate edges.

Optionally, in any of the foregoing embodiments of a knife, the knife is symmetrical about a third plane that extends through the top side, the bottom side, and the beveled faces, perpendicular to the first plane.

In some embodiments, a method of forming a cutter head body comprises forming at least one groove in an outer periphery of a cutter head body blank, wherein the cutter head body blank further includes a first end, an opposite second end, and a rotational axis that extends through the ends, and the outer periphery extends between the ends and around the rotational axis, wherein the groove has a front wall, a rear wall, an opening that extends from an upper edge of the front wall to an upper edge of the rear wall, and a bottom that extends from a lower edge of the front wall to a lower edge of the rear wall, wherein the front wall is substantially planar and the rear wall defines a first locking feature that extends, parallel to the rotational axis, between the first end and the second end, wherein the front wall and the rear wall are inclined toward a groove center axis that extends through the opening and the bottom, such that a width of the opening from the upper edge of the front wall to the upper edge of the rear wall is less than a width of the bottom from the lower edge of the front wall to the lower edge of the rear wall.

Optionally, the width of the bottom is greater than a height of the front wall from the lower edge to the upper edge thereof.

Optionally, in any of the foregoing embodiments of the method, a height of the rear wall from the lower edge to the upper edge thereof is greater than the width of the bottom.

Optionally, in any of the foregoing embodiments of the method, the rear wall has a first portion that extends from the upper edge thereof to an upper edge of the first locking feature, and a second portion that extends from a lower edge of the first locking feature to the lower edge of the rear wall, and wherein the first portion of the rear wall is coplanar with the second portion of the rear wall.

Optionally, in any of the foregoing embodiments of the method, the first locking feature is an elongated ridge or channel. In some such embodiments, the ridge or channel is arcuate or semi-circular in cross-section. For example, in some such embodiments, the first locking feature is an elongated ridge that is semi-circular in cross-section.

Optionally, in any of the foregoing embodiments of the method, the bottom has a substantially flat portion, a first curved portion that extends from the lower edge of the front wall to the flat portion, and a second curved portion that extends from the flat portion to the lower edge of the rear wall. Alternatively, the bottom optionally has a substantially flat portion, a curved portion that extends from the lower edge of the front wall to the flat portion, and a recess that extends from the flat portion to the lower edge of the rear wall, to thereby accommodate a first end of a knife within the groove while an opposite second end of the knife is positioned for use.

Optionally, in any of the foregoing embodiments of the method, the front wall is connected to the outer periphery by a surface that is inclined away from the groove center axis.

In some embodiments, a gib for holding a knife in a groove of a cutter head has a front side and a rear side that are inclined toward one another, a bottom side, a top side, a first end and an opposite second end, and a through-hole that extends through the top side and the bottom side. The gib is symmetrical about a first center plane that extends through the top side, the bottom side, the ends, and the through-hole. At least a portion of the through-hole has a threaded interior configured to engage a threaded exterior of a fastener.

Optionally the top side of the gib has a recessed portion that is in axial alignment with the through-hole, and a diameter of the recessed portion is greater than a diameter of the through-hole.

Optionally, in any of the foregoing embodiments of the gib, a top end of the fastener is recessed within the recessed portion of the gib or within the through-hole while the gib is in the second position.

Optionally, in any of the foregoing embodiments of the gib, the gib is symmetrical about a second center plane that extends through the front side, the rear side, and the through-hole, perpendicular to the first center plane.

Optionally, in any of the foregoing embodiments of the gib, the top side of the gib has a first portion that is curved in cross-section, a second portion that joins the first portion to the front side of the gib, and a third portion that joins the first portion to the rear side of the gib. In that case, optionally the second and third portions are flat and coplanar.

Optionally, in any of the foregoing embodiments of the gib, the bottom side of the gib has a first portion that is flat in cross-section, a second portion that joins the first portion of the bottom side to the front side of the gib, a third portion that joins the first portion of the bottom side to the rear side of the gib, and the second and third portions are inclined away from one another in cross-section.

While the present disclosure describes and illustrates cutter head systems and components that are suitable for use in planers, the skilled artisan will readily understand how to adapt the disclosed cutter head bodies, gibs/gib assemblies, and knives for use in other woodworking machinery without departing substantially from the scope of the present disclosure.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

What is claimed is:

1. A cutter head comprising:
a cutter head body having a first end, an opposite second end, a rotational axis that extends through the ends, an outer periphery, and a groove formed in the outer periphery between the ends,
wherein the groove has a front wall, a rear wall, an opening that extends from an upper edge of the front wall to an upper edge of the rear wall, and a bottom that extends from a lower edge of the front wall to a lower edge of the rear wall,
wherein the front wall is substantially planar and the rear wall defines a first locking feature that extends, parallel to the rotational axis, between the first end and the second end,
wherein the front wall and the rear wall are inclined toward a groove center axis that extends through the opening and the bottom, such that a width of the opening from the upper edge of the front wall to the upper edge of the rear wall is less than a width of the bottom from the lower edge of the front wall to the lower edge of the rear wall.

2. The cutter head of claim 1, wherein the width of the bottom is greater than a height of the front wall from the lower edge to the upper edge thereof.

3. The cutter head of claim 1, wherein a height of the rear wall from the lower edge to the upper edge thereof is greater than the width of the bottom.

4. The cutter head of claim 3, wherein the rear wall has a first portion that extends from the upper edge thereof to an upper edge of the first locking feature, and a second portion that extends from a lower edge of the first locking feature to the lower edge of the rear wall, and wherein the first portion of the rear wall is coplanar with the second portion of the rear wall.

5. The cutter head of claim 1, wherein the first locking feature is an elongated ridge or channel.

6. The cutter head of claim 5, wherein the ridge or channel is arcuate or semi-circular in cross-section.

7. The cutter head of claim 6, wherein the first locking feature is an elongated ridge that is semi-circular in cross-section.

8. The cutter head of claim 1, wherein the bottom has a substantially flat portion, a first curved portion that extends from the lower edge of the front wall to the flat portion, and a second curved portion that extends from the flat portion to the lower edge of the rear wall.

9. The cutter head of claim 1, wherein the bottom has a substantially flat portion, a curved portion that extends from the lower edge of the front wall to the flat portion, and a recess that extends from the flat portion to the lower edge of the rear wall, to thereby accommodate a first end of a knife within the groove while an opposite second end of the knife is positioned for use.

10. The cutter head of claim 1, wherein the front wall is connected to the outer periphery by a surface that is inclined away from the groove center axis.

11. A cutter head system comprising:
a cutter head as recited in claim 1; and
a gib that has a front side and a rear side that are inclined toward one another, a bottom side, a top side, a first end and an opposite second end, and a through-hole that extends through the top side and the bottom side,
wherein the gib is symmetrical about a first center plane that extends through the top side, the bottom side, the ends, and the through-hole, and
wherein at least a portion of the through-hole has a threaded interior configured to engage a threaded exterior of a corresponding fastener, such that rotation of the fastener in a first rotary direction within the through-hole is operable to bring a bottom end of the fastener into contact with the bottom of the groove to thereby urge the gib from a first position, in which the bottom side of the gib is in contact with the bottom of the groove, to a second position in which the top side of the gib is proximal to the opening and the front side of the gib is in abutment with the front wall of the groove to thereby clamp a knife between the rear side of the gib and the rear wall of the groove.

12. The cutter head system of claim 11, further including the fastener, wherein the fastener is a screw.

13. The cutter head system of claim 12, wherein the top side of the gib has a recessed portion that is in axial alignment with the through-hole, and a diameter of the recessed portion is greater than a diameter of the through-hole.

14. The cutter head system of claim 13, wherein a top end of the fastener is recessed within the recessed portion of the gib or within the through-hole while the gib is in the second position.

15. The cutter head system of claim 11, wherein the gib is symmetrical about a second center plane that extends through the front side, the rear side, and the through-hole, perpendicular to the first center plane.

16. The cutter head system of claim 11, wherein the top side of the gib has a first portion that is curved in cross-section, a second portion that joins the first portion to the front side of the gib, and a third portion that joins the first portion to the rear side of the gib.

17. The cutter head system of claim 16, wherein the second and third portions are flat and coplanar.

18. The cutter head system of claim 11, wherein the bottom side of the gib has a first portion that is flat in cross-section, a second portion that joins the first portion of the bottom side to the front side of the gib, a third portion that joins the first portion of the bottom side to the rear side of the gib, and the second and third portions are inclined away from one another in cross-section.

19. A method of forming a cutter head as recited in claim 1, the method comprising: forming said groove in an outer periphery of a cutter head body blank, wherein the cutter head body blank defines the first end, the opposite second end, and the rotational axis, to thereby form the cutter head body.
